(19) United States
(12) Patent Application Publication
(10) Pub. No.: US 2004/0151823 A1
(43) Pub. Date: Aug. 5, 2004

(54) Edible emulsion containing highly unsaturated fat

(75) Inventors: Stephen Charles Daniels, Kempten (DE); Christel Karine Reiffers-Magnani, Vlaardingen (NL)

Correspondence Address: UNILEVER, PATENT DEPARTMENT, 45 RIVER ROAD, EDGEWATER, NJ, 07020, US

(73) Assignee: Unilever Bestfoods North America, Division of Conopco, Inc.

(21) Appl. No.: 10/738,339

(22) Filed: Dec. 17, 2003

(30) Foreign Application Priority Data
Dec. 23, 2002 (DE) 20220081.7

(51) Int. Cl. A23D 7/00

(52) U.S. Cl. 426/602

(57) ABSTRACT

An edible oil in water emulsion comprising 40-99 wt. % of a continuous aqueous phase which phase contains 0.05-15 wt. % of a protein calculated on aqueous phase and, preferably, a thickener in an amount of 0.01-3 wt. %, 1-60 wt. % of a dispersed fat phase, the fat phase comprising 0.01-0.2 wt. % of alpha-tocopherol and a triglycerides mixture containing 10-80 wt. % of mono-unsaturated fatty acid residues, 10-80 wt. % of polyunsaturated fatty acid residues, 3-15 wt. % of omega-3 fatty acid residues, the balance up to 100 wt. % consisting of saturated fatty acid residues, fatty acid residues being calculated on fat phase, which emulsion is characterized in that it contains 0.005-0.05 wt. % of delta-tocopherol, while the weight ratio of delta-tocopherol and alpha-tocopherol in the emulsion is selected from the range 5 to 0.25.

### FIELD OF THE INVENTION

The present invention deals with a low fat edible O/W-emulsion of which the dispersed fat phase contains a substantial amount of highly unsaturated triglyceride fat.

### BACKGROUND AND RELATED ART

Spreads which consist of a water continuous emulsion often are derived from dairy ingredients such as the spread described in EP841856. Such dairy based spread is appreciated because of its fine taste and flavour. However, its fat phase consists of expensive milk fat which contains a substantial amount of saturated fat. Vegetable fats have a high content of unsaturated fatty acids such as oleic acid, linoleic acid and linolenic acid.

From a nutritional point of view vegetable fats such as are sunflower seed oil, rapeseed oil, corn oil, linseed oil and soybean oil, are preferred over milk fat. EP1065937 describes spreads in which the milk fat has been replaced partially by vegetable fat.

Emulsion spreads which are water continuous and of which the fat phase contains a high amount of unsaturated fatty acids are known for suffering from quick taste deterioration. Particularly the presence of highly unsaturated omega-3 polyunsaturated fatty acids (PUFA's) cause problems. These omega-3 PUFA's, also denoted as n-3 PUFA's contain at least three double bonds, of which the first double bond is between carbon atoms 3 and 4 counted from the terminal end of the carbon chain. Besides linolenic acid also eicosapentaenoic acid (EPA) and docosahexaenoic acid (DHA) belong to the omega-3 PUFA's. The latter fatty acids are characteristic for marine oils.

Those spreads can be given a reasonable shelf life only by incorporating an effective amount of the potent antioxidant EDTA. EDTA, however, being considered an artificial chemical additive, preferably is avoided in food compositions. Tocopherols are known food anti-oxidants which are usually available as a preparation isolated from a natural vegetable source. Such preparations comprise a mixture of several tocopherols denoted as alfa-, beta-, gamma- and delta-tocopherols which are present in varying amounts depending on the source. See for example JAOCS 1991, 68 (11), 881-883; JAOCS 2001, 78 (4), 361-367; Eur. J. Lip. Sc. and Techn. 2000, 102 (10), 624-629; JAOCS 1998, 75 (7), 813-822 and J. Agr. and Food Chem. 1995, 43 (9), 2345-2350. The anti-oxidant activity of the tocopherols has been shown to be restricted to a concentration range specific for each tocopherol. Outside this range the anti-oxidant activity is absent or may even turn into a pro-oxidant activity. Moreover, the tocopherols also may exhibit an adverse interaction by which they mutually inhibit their anti-oxidant activity. The prior art tocopherol preparations, although useful in less demanding compositions, can not realize flavour stability in the type of emulsions of the present invention.

### SUMMARY OF THE INVENTION

We have found an edible low fat water continuous emulsion which exhibits good flavour stability despite the presence of a highly unsaturated fat phase. The emulsion as defined in claim 1 is characterized by the presence of a relatively high amount of delta-tocopherol in comparison to the alpha-tocopherol also present in the emulsion.

### DETAILS OF THE INVENTION

The water continuous emulsion of the present invention contains 1-60 wt. %, preferably 10-40 wt. %, more preferably 20-30 wt. % of a dispersed fat phase which substantially consists of a triglyceride fat blend. The composition of the blend may vary within the ranges shown by Table I.

TABLE I

| | Range claim 1 | Preferred ranges |
|---|---|---|
| Fat phase | wt. % | wt. % |
| composition (1) | on fat blend | on fat blend |
| PUFA | 10-80 | 40-80, 40-65 |
| omega-3 PUFA | 3-15 | 4-10, 4-8 |
| MUFA | 10-80 | 20-50, 20-45 |
| SAFA | balance to 100 | 10-30, 15-25 |
| delta-tocopherol | 0.005-0.05 (2) | 0.005-0.03 (2) |

(1) PUFA: poly-unsaturated fatty acid residues; omega-3 PUFA: PUFA which is unsaturated at least between carbon atoms 3 and 4; MUFA: mono-unsaturated fatty acid residues; SAFA: saturated fatty acid residues.
(2) On total emulsion

The fat blend used for preparing the present emulsion is characterised by a high content of unsaturated fatty acid residues, particularly of polyunsaturated fatty acids. Unsaturated fatty acids are desired components of fat blends because their presence has been shown to contribute to the fat's nutritional value. Such fats have a favourably low Keys number. A fat's Keys number is a measure for the effect of fat intake on blood cholesterol level and thus is an indicator how fat consumption affects cardiovascular health. A high Keys number means that consumption of the fat adversely affects the blood cholesterol level. The Keys number therefore distinguishes fats which are related to a high incidence of cardiovascular diseases from fats which even counteract the incidence of such diseases.

The Keys number (KN) is calculated using the formula:

KN=C12-C16+trans−0.5 PUFA,

wherein “C12-C16” indicates the weight percentages (related to total fat) of saturated fatty acid residues with 12 to 16 carbon atoms, “trans” is the percentage of fatty acid residues containing one or more trans unsaturated double bonds and “PUFA” indicates the percentage of all fatty acid residues containing 2 or more double bonds all of which should be in the cis-configuration.

The fat blend used in the present invention preferably has a low Keys number which preferably is <−0.5. The low Keys number is caused by a relatively low amount of saturated fatty acids (SAFA) which preferably is in the range 10-30 wt. %, more preferably in the range 15-25 wt. %, by the total content of C12, C14 and C16 fatty acids which preferably is in the range 12-20 wt. % and by the content of trans fatty acids which preferably is less than 1 wt. %.

In order to keep the content of saturated fatty acids low, the preferred amount of stearic acid is in the range 1-8 wt. %.

The critical measure for obtaining flavour stability of the present emulsion spread without employing a substantial amount of EDTA is dosing delta-tocopherol (d-tocopherol) in an amount which is relatively high in relation to the amount of alpha-tocopherol which tocopherol is an ever present component of fat containing emulsions. The emulsion of the invention contains delta-tocopherol in a concentration chosen from the range 0.005-0.05, peferably 0.005-0.03 wt. %. The optimum concentration depends on the composition of the spread, particularly on the used fat phase. The skilled man can easily establish a suitable concentration by some trial experiments. For obtaining the highly effective flavour stabilisation The weight ratio of delta-tocopherol and alpha-tocopherol in the present emulsion must be selected from the range 5 to 0.25 and preferably is at least 2.

For suitably dosing of delta-tocopherol preferably a high purity delta-tocopherol preparation is chosen in which tocopherols other than d-tocopherol should be present in low concentrations.

According to a preferred embodiment the emulsion also contains an effective amount of citric acid. A suitable concentration of citric acid is chosen from the range 0.04-0.08 wt. %. The optimum concentration depends on the composition of the spread, particularly on the used fat phase. The skilled man can easily establish a suitable concentration by some trial experiments. Citric acid is applied preferably as a 30 wt. % aqueous solution.

The spread composition preferably contains no substantial amount of EDTA. Although according to the state of the art the presence of EDTA is essential for the flavour stability of products with highly unsaturated fat blends, flavour stability in the emulsions of the invention can be maintained without EDTA during a shelf life of 9 weeks. The invention has the benefit of providing a stable emulsion spread containing a healthy, but highly perishable fat blend.

For preparing the blend of the fat phase any vegetable oil suited for spread preparation may be selected, provided the blend complies with the fat phase specification as defined in claim 1. The blend preferably contains an oil component with a relatively high content of omega-3 polyunsaturated fatty acids such as linseed oil. Other oils suitable for preparing the fat blend comprise sunflower seed oil, rapeseed oil, corn oil and soybean oil. Corn germ oil is a preferred fat phase ingredient. For taste reasons dairy fat can be included provided the fatty acids composition does not depart from the fatty acid ranges as defined in claim 1.

The presence of structuring solid fat in the blend is optional and may be advantageous when a more plastic spread consistency is desired. Suitable structuring fats have a N-line preferably in the range shown by table II.

TABLE II
Solid fat content structuring fat

| | |
|---|---|
| N₂₀ | 75-85 |
| N₃₀ | 55-65 |
| N₄₀ | 15-25 |

Such commercially available fats are for example palm fat fractions and an interesterified mixtures of palm fat (or its stearin fraction) and palm kernel fat. The actually applied amount is attuned to the desired spread consistency and could be found by some trial preparations.

The water continuous emulsion according to the invention may have a fat content as low as 1 wt. %. Such emulsion usually is liquid like milk. When a more spoonable or plastic consistency is desired, higher fat contents and the presence of a thickener in the aqueous phase is recommended.

In the water continuous emulsions according to the invention the optional presence of 0.01-3 wt. % of a structuring thickener stabilizes the aqueous phase and prevents syneresis. For the purpose of the invention the term thickener should be understood as not encompassing protein. The thickener preferably is selected from the group consisting of locust bean gum, guar gum, tara gum, amylopectin, methylcellulose, alginate, starch, modified starch and high molecular weight pectin. Locust bean gum and guar gum are most preferred. It will be appreciated that each individual thickener will have its own optimum concentration which may depend on other characteristics of the emulsion such as the protein source, pH and salt content. For locust bean gum, generally a suitable concentration is 0.2-0.4 wt. %.

The present emulsion also contains 0.05 to 15 wt. % of a protein which acts as a structuring agent of the aqueous phase. For imparting to the emulsion a spreadable consistency protein should be present in a concentration which is chosen from the upper half of the claimed range.

Preferably the protein is selected from the group consisting of milk protein, soy protein and pea protein. 1-100 wt. % of the protein may be milk protein. Milk protein is preferred because of its positive effect on taste and flavour of the final product. Suitable sources of milk protein are milk, cream, skimmed milk powder, butter milk powder, butter serum powder, whey powder, whey protein concentrate, whey protein isolate and caseinate. Most preferred is butter milk protein because of its superb taste and flavour contribution.

Preferably 0.2 to 1.0 wt. % of gelatin is present in the emulsion. Gelatin may further improve the emulsion's spreadability and mouthfeel. Since gelatin preparations may have varying bloom strengths, the amount of gelatin should be adapted to its bloom strength.

On behalf of some groups of consumers a gelatin replacer may be used. Gelatin replacers are substances or compositions which have a mouthfeel, a water binding performance and melting properties which are similar to those of gelatin. Suitable replacers which are described in, inter alia, European Patent Application EP 496466 and in EP 474299 are carrageenan, pectins and propylene glycol alginate. Carrageenan is suitably used in a concentration of 0.30 wt. %.

According to one preferred embodiment the emulsion of the invention has a consistency which is suitable for spreading on bread.

According to another preferred embodiment the emulsion has a spoonable consistency.

Optionally, the emulsion according to the invention comprises further useful or tasty ingredients such as herbs, salt, flavour and colouring agents.

On behalf of microbiological preservation the aqueous phase preferably is acidified using edible acids such as are citric acid, acetic acid and lactic acid. Preferably a microbiological acidification is used, employing a yoghurt culture, preferably a standard, thermophilic, mild yoghurt culture. Preferably the pH of the aqueous phase is in the range 3.7-5.8, more preferably in the range 4.2-5.5, still more preferably in the range 4.4-4.7. A suitable pH is about 4.65.

The emulsion can be prepared using the common spread manufacturing procedures which are known to the man skilled in the art. See the examples section for a standard procedure. Such procedure is quite general and can be modified within the restrictions imposed by the broadest patent claim. For example, the fermentation step, when desired, may be substituted by chemical acidification, as described hereinbefore.

All percentages in this specification are weight percentages calculated on emulsion, unless specified otherwise.

The following examples illustrate the invention.

### General

For the preparation of the emulsion of the invention the following standard procedure has appeared to be suitable. All water and water soluble ingredients (except gelatin and cooking salt) are mixed at about 60° C. This mixture kept at a temperature of 85° C. for 15-20 minutes. The pasteurised mix is cooled to 46° C. and gelatin (in the form of a solution) and salt are added, followed by homogenisation at 200 bar. To the emulsion having a temperature of 44° C. a culture of yoghurt bacteria is added and fermentation is allowed to proceed until a pH of about 4.8 ia attained. Then citric acid (preferably in the form of a 30% aqueous solution) is added. The pH is set at a final value of about 4.65. Fermentation is stopped by heating the mixture to 64° C. The aqueous phase is stored until admixture with the fat phase.

A specific oil phase is prepared to which a d-tocopherol preparation with a high purity is added. The oil phase is heated (about 55° C.) and is dosed in-line into the aqueous phase. The mixture is immediately heated to 76° C. and homogenized at 280-300 bar. The homogenized product is filled into containers, cooled to below 10° C. by conducting it through a cooling tunnel and stored under chilled conditions. Optionally, flavour variants may be produced by adding after the final homogenisation step e.g. a pre-pasteurised savoury preparation such as one based on tomato or on basil or on a mixture of herbs.

### EXAMPLE 1

### Spread Product

A spread product with a content of about 24 wt. % fat was prepared with the ingredients of Table III using the standard procedure as described hereinbefore.

TABLE III

| Ingredients | wt. % |
|---|---|
| Fat blend (1) | 19.20 |
| Butter milk powder | 17.10 |
| Dairy fat (3) | 4.06 |
| Cooking salt | 0.80 |
| Gelatin | 0.45 |
| Citric acid (4) | 0.20 |
| Locust bean gum | 0.12 |
| Delta tocopherol (2) | 0.025 |
| Corn germ oil | 2.40 |
| Defatted milk | 3.95 |
| Yoghurt culture | 0.0528 |
| Water | 51.65 |
| TOTAL | 100 |

(1) Fat blend consisting of a blend of Linola oil ™ (46%), sunflower oil (19%), rapeseed oil (22%) and an interesterified mixture (1:1) of palm oil stearin and palm kernel oil (13%).
(2) Tocopherol preparation ex Sigma Aldrich (T2028) containing 97 wt. % of delta-tocopherol.
(3) Added as 40% cream
(4) Added as 30% aq. solution

The main characteristics of the obtained spread are summarized in Table IV.

TABLE IV

| | wt. % |
|---|---|
| Product composition | |
| Fat phase | 24 |
| Total protein | 6.5 |
| Cooking salt | 0.8 |
| Delta-tocopherol | 0.025 |
| Alpha-tocopherol | 0.07 |
| Ratio delta-/alpha-tocopherol | 0.35 |
| Total dry matter (incl. fat) | 41.5 |
| Water | 58.5 |
| pH | 4.65 |
| Fat phase composition | |
| Saturated fatty acids | 21 |
| of which C12-C16 fatty acids | 16 |
| of which stearic acid | 4 |
| Mono-unsaturated fatty acids | 26 |
| Poly-unsaturated fatty acids | 52 |
| Omega-3 fatty acids | 6 |
| Cholesterol | <0.015 |
| Trans fatty acids | <0.1 |
| Keys-number | −14 |

After 9 weeks of chilled storage the spread was submitted to a panel for flavour assessment. The flavour appeared to comply with standards usual for that type of food products.

1. An edible oil in water emulsion comprising 40-99 wt. % of a continuous aqueous phase which phase contains 0.05-15 wt. % of a protein calculated on aqueous phase, and 1-60 wt. % of a dispersed fat phase, the fat phase comprising 0.01-0.2 wt. % of alpha-tocopherol and
a triglycerides mixture containing
10-80 wt. % of mono-unsaturated fatty acid residues,
10-80 wt. % of polyunsaturated fatty acid residues,
3-15 wt. % of omega-3 fatty acid residues, the balance up to 100 wt. % consisting of saturated fatty acid residues, fatty acid residues being calculated on fat phase,
which emulsion contains 0.005-0.05 wt. % of delta-tocopherol, while the weight ratio of delta-tocopherol and
alpha-tocopherol in the emulsion is selected from the range 5 to 0.25.

2. An edible emulsion according to claim 1 which emulsion comprises 60-90 wt. % of an aqueous phase and 10-40 wt. % of a dispersed fat phase.

3. An edible emulsion according to claim 1 which emulsion comprises 70-80 wt. % of an aqueous phase and 20-30 wt. % of a dispersed fat phase.

4. An edible emulsion according to claim 1, which emulsion contains 0.005-0.03 wt. % of delta-tocopherol.

5. An edible emulsion according to claim 1, in which emulsion delta-tocopherol and alpha-tocopherol are present in a weight ratio being at least 2:1.

6. An edible emulsion according to claim 1, in which emulsion the composition of the fat phase is such that its Keys number is <−0.5.

7. An edible emulsion according to claim 1, in which emulsion the fat phase contains 20-45 wt. % of mono-unsaturated fatty acid residues, calculated on fat phase.

8. An edible emulsion according to claim 1, in which emulsion the emulsion comprises 40-65 wt. % of polyunsaturated fatty acid residues, calculated on fat phase.

9. An edible emulsion according to claim 1, in which emulsion the emulsion comprises 4-10 wt. %, preferably 4-8 wt. % of omega-3 fatty acid residues, calculated on fat phase.

10. An edible emulsion according to claim 1, in which emulsion the fat phase contains 15-25 wt. % of saturated fatty acid residues, calculated on fat phase.

11. An edible emulsion according to claim 1, in which emulsion the fat phase contains 12-20 wt. % of saturated fatty acid residues having a linear carbon chain with 12-16 carbon atoms, fatty acid residues calculated on fat phase.

12. An edible emulsion according to claim 1, in which emulsion the fat phase contains 1-8 wt. % of stearic acid residues, calculated on fat phase.

13. An edible emulsion according to claim 1, in which emulsion the fat phase contains <1 wt. % of trans fatty acid residues, calculated on fat phase.

14. An edible emulsion according to claim 1, in which emulsion the fat phase contains at least 1 wt. % of dairy fat, calculated on fat phase.

15. An edible emulsion claim 1, which emulsion contains 0.04-0.08 wt. % of citric acid.

16. An edible emulsion according to claim 1, in which emulsion the aqueous phase contains 0.01-3 wt. % of a thickener calculated on aqueous phase.

17. An edible emulsion according to claim 1, in which emulsion the aqueous phase contains 0.2 to 0.4 wt. % of locust bean gum, percentages calculated on aqueous phase.

18. An edible emulsion according to claim 1, in which emulsion the aqueous phase contains 0.2 to 1.0 wt. % of either gelatin or carrageenan or a mixture of both, percentages calculated on aqueous phase.

19. An edible emulsion according to claim 1, in which emulsion the aqueous phase contains 0.05-10 wt. % of a protein, percentages calculated on aqueous phase.

20. An edible emulsion according to claim 1, in which emulsion 1-100 wt. % of the protein is milk protein.

21. An edible emulsion according to claim 1, in which emulsion the pH of the aqueous phase is in the range 3.7-5.8.

22. An edible emulsion according to claim 1, in which emulsion the pH of the aqueous phase is in the range 4.2-5.5.

23. An edible emulsion according to claim 1, in which emulsion the pH of the aqueous phase is in the range 4.4-4.7.

24. An edible emulsion according to claim 1, which emulsion has a consistency which is suitable for spreading on bread

25. An edible emulsion according to claim 1, which emulsion has a spoonable consistency.
